(19) United States
(12) Patent Application Publication
(10) Pub. No.: US 2016/0328752 A1
(43) Pub. Date: Nov. 10, 2016

(54) NATIVE CREATIVE GENERATION USING HASHTAGGED USER GENERATED CONTENT

(71) Applicant: Google Inc., Mountain View, CA (US)

(72) Inventors: Sofia Andrianakou, Mountain View, CA (US); Yuanying Xie, Mountain View, CA (US)

(21) Appl. No.: 14/356,260

(22) PCT Filed: Jan. 24, 2014
(86) PCT No.: PCT/GR2014/000008

§ 371 Date: May 5, 2014

(51) Int. Cl. G06Q 30/02; G06Q 50/00; G06F 17/30

(52) U.S. Cl. CPC G06Q 30/0276; G06F 17/30628; G06F 17/30722; G06Q 30/0256; G06Q 50/01

(57) ABSTRACT

Methods, systems and apparatus include computer programs encoded on a computer-readable storage medium for creating a campaign. A method includes: identifying a repository of content, the repository including a plurality of content items, each indexed by a hashtag that is associated with a respective content item; receiving a search query from an entity associated with a brand, the query including one or more of a hashtag, category, or brand; retrieving content from the repository based on the search query; presenting the content to the entity and receiving a selection of one or more content items from the presented content for inclusion in a campaign; arid creating a campaign including generating one or more creatives based on the selection for distribution based on selection criteria associated with the campaign.

### BACKGROUND

This specification relates to information presentation.

The Internet provides access to a wide variety of resources. For example, video and/or audio files, as well as web pages for particular subjects or particular news articles, are accessible over the Internet. Access to these resources presents opportunities for other content (e.g., advertisements) to be provided with the resources. For example, a web page can include slots in which content can be presented. These slots can be defined in the web page or defined for presentation with a web page, for example, along with search results.

Slots can be allocated to content sponsors through a reservation system or an auction. For example, content sponsors can provide bids specifying amounts that the sponsors are respectively willing to pay for presentation of their content. In turn, a reservation can be made or an auction can be performed, and the slots can be allocated to sponsors according, among other things, to their bids and/or the relevance of the sponsored content to content presented on a page hosting the slot or a request that is received for the sponsored content.

### SUMMARY

In general, one innovative aspect of the subject matter described in this specification can be implemented in methods that include a method for creating a campaign. A method includes: identifying a repository of content, the repository including a plurality of content items, each indexed by a hashtag that is associated with a respective content item; receiving a search query from an entity associated with a brand, the query including one or more of a hashtag, category, or brand; retrieving content from the repository based on the search query; presenting the content to the entity and receiving a selection of one or more content items from the presented content for inclusion in a campaign; and creating a campaign including generating one or more creatives based on the selection for distribution based on selection criteria associated with the campaign.

In general, another aspect of the subject matter described in this specification can be implemented in computer program products. A computer program product is tangibly embodied in a computer-readable storage device and comprises instructions. The instructions, when executed by a processor, cause the processor to: identify a repository of content, the repository including a plurality of content items, each indexed by a hashtag that is associated with a respective content item; receive a search query from an entity associated with a brand, the query including one or more of a hashtag, category, or brand; retrieve content from the repository based on the search query; present the content to the entity and receiving a selection of one or more content items from the presented content for inclusion in a campaign; and create a campaign including generating one or more creatives based on the selection for distribution based on selection criteria associated with the campaign.

In general, another aspect of the subject matter described in this specification can be implemented in systems. A system includes one or more processors and one or more memory elements including instructions. The instructions, when executed, cause the one or more processors to: identify a repository of content, the repository including a plurality of content items, each indexed by a hashtag that is associated with a respective content item; receive a search query from an entity associated with a brand, the query including one or more of a hashtag, category, or brand; retrieve content from the repository based on the search query; present the content to the entity and receiving a selection of one or more content items from the presented content for inclusion in a campaign; and create a campaign including generating one or more creatives based on the selection for distribution based on selection criteria associated with the campaign.

These and other implementations can each optionally include one or more of the following features. Identifying the repository can include gathering content from plural, different content sources that are associated with hashtags and storing the content in the repository. Gathering the content can include gathering content from at least two different social networks. Gathering content can include gathering metadata related to an engagement metric associated with a specific content item and storing the metadata along with the content in the repository. The metadata can include one or more of a number of affinity designations, or number of publications or re-publications of the specific content item. Presenting can include presenting the metadata for each content item presented. Gathering content can include integrating a portion of an application that generates the creative in one or more networks or applications that are the source of the content. The search query can include only a hashtag and retrieving can include retrieving top ranked content from the repository that is associated with the hashtag. The search query can include a hashtag and a category and retrieving can include retrieving top ranked content from the repository that are associated with the hashtag and the category. The category can be a type of content item. Presenting the content can include presenting top ranked content from the repository based on one or more measures of popularity. Generating the one or more creatives can include generating one creative from the selection and content received from the entity. The content received from the entity can be an identification of a landing page to be associated with the creative. The content received can be textual content to include along with the selection in the creative. The selection can include two content items and generating the one or more creative can include generating two different creatives from the selection each including one of the two content items. When the search query does not include a hashtag retrieving content from the repository based on the search query can include identifying one or more hashtags that are related to the search query and retrieving top ranked content from the repository that is associated with the one or more hashtags. Particular implementations may realize none, one or more of the following advantages. An entity can use, for example in association with an advertising campaign, creative content generated by users who have an affinity towards the entity. Content for a campaign can be automatically created for an entity using far less input from the entity as compared to the entity creating content from scratch. Content that is presented in association with a campaign can be selected from a set of content items that are most popular among customers of the entity associated with the campaign.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for presenting content.

FIG. 2 is a block diagram of an example system for providing content.

FIG. 3 is a flowchart of an example process for creating a campaign.

FIG. 4 illustrates an example content gallery user interface.

FIG. 5 is a block diagram of computing devices that may be used to implement the systems and methods described in this document, as either a client or as a server or plurality of servers.

Like reference numbers and designations in the various drawings indicate like elements.

### DETAILED DESCRIPTION

Hashtags provide a ready means for grouping content, so as to enable ease of location of content that includes the tagged material. A repository of content including, for example a plurality of content items each grouped or indexed by a hashtag can be identified. A hashtag, as used herein, refers to a word or phrase that is prefixed with a non-alphabetic symbol (such as the # symbol). In some implementations, a hashtag can be used to index content, such as content that includes or is otherwise associated with the hashtag. For example, a hashtag can be included in or with content used in one or a plurality of social networking environments. In some implementation, a search query including one or more of a hashtag, category, or brand can be received from an entity associated with a brand. Content that is grouped or otherwise associated with a hashtag derived from the contents of the query can be retrieved from the repository based on the search query and presented to the entity. A selection of one or more of the presented content items can be received and a campaign can be created for the entity, including the generating of one or more creatives based on the selected content for distribution based on selection criteria associated with the campaign.

For situations in which the systems discussed here collect information about users, or may make use of information about users, the users may be provided with an opportunity to control whether programs or features collect user information (e.g., information about a user's social network, social actions or activities, profession, demographics, a user's preferences, or a user's current location), or to control whether and/or how to receive content from the content server that may be more relevant to the user. In addition, certain data may be treated in one or more ways before it is stored or used, so that certain information about the user is removed. For example, a user's identity may be treated so that no identifying information can be determined for the user, or a user's geographic location may be generalized where location information is obtained (such as to a city, ZIP code, or state level), so that a particular location of a user cannot be determined. Thus, the user may have control over how information about the user is collected and used by a content server. For situations in which user-generated content (e.g., content associated with a hashtag) is used, such use may only be performed with content to which the user has given consent of such use:

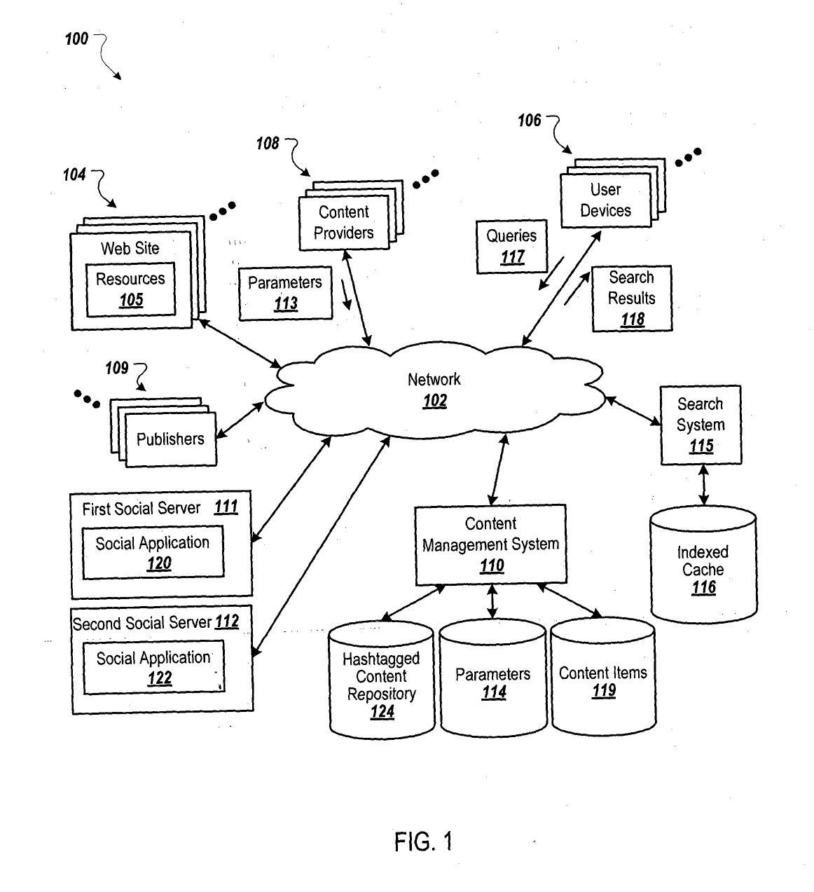

FIG. 1 is a block diagram of an example environment 100 for providing content to a user. The example environment 100 includes a network 102, such as a local area network (LAN), a wide area network (WAN), the Internet, or a combination thereof. The network 102 connects websites 104, user devices 106, content providers 108, publishers 109, a content management system 110, a first social server system 111, and a second social server system 112. The example environment 100 may include many thousands of websites 104, user devices 106, content providers 108, and publishers 109. The content management system 110 may be used for selecting and providing content in response to requests for content. The content providers 108 can be, for example, advertisers. Other types of content providers are possible. While only two social servers systems are shown, more are possible. Each social server system as presented represents a social environment that may include plural servers for supporting interactions, content delivery and other services in association with a single social service.

A user device 106 is an electronic device that is under control of a user and is capable of requesting and receiving resources 105 over the network 102. Example user devices 106 include personal computers, tablet computers, mobile communication devices (e.g., smartphones), televisions, set top boxes, personal digital assistants and other devices that can send and receive data over the network 102. A user device 106 typically includes one or more user applications, such as a web browser, to facilitate the sending and receiving of data over the network 102. The web browser can interact with various types of web applications, such as a game, a map application, or an e-mail application, to name a few examples.

The first social server system 111 and the second social server system 112 allow users to interact with other users within a social framework. The first social server system 111 and the second social server system 112 each provide a social presence for users in the environment 100. For example, the first social server system 111 and the second social server system 112 can be associated with their own respective social application (e.g., a social application 120 and a social application 122). The social application 120 and the social application 122 can allow a user of a user device 106 to share information in a respective social network. For example, the social application 120 and the social application 122 can each be associated with a social networking website that users can use, for example, to identify friends and social groups (e.g., circles), send and receive email, post messages and multi-media (e.g. photos, video, audio), track social events, provide updates and so on.

A user of a user device 106 can use the social application 120 or the social application 122 to post an update for the user in a social context, such update enabling content to be distributed to one or more other users in the social network. In some implementations, one or both of the first social server system 111 or the second social server 112 can, in response to the update, provide the update to one or more subscribers that the user has authorized to receive the update. For example, subscribers may be subscribed to an activity stream associated with the user, and may be enabled to view the update in the user's activity, stream. An activity stream can be used to present recent updates posted by one or more users in the social network. The user can, for example, authorize a content provider 108 and/or the content management system 110 to receive the update.

The update can be, for example, a comment by the user on content exposed to the user (e.g., in association with the social application 120 or the social application 122), such as a content item posted to their activity stream or to another user's activity stream, or some other content. As another example, the update can be a comment posted by the user on a blog. As yet another example, the update can be a designation that the user likes or dislikes certain content. The user can, for example, designate that they like or dislike a content item posted to their activity stream or to another user's activity stream, or some other content. An update can also be of the form of another type of interaction with a content item in a user's activity stream, such as a designation to share or re-publish the content item. Content included in or referenced as part of an update can include a hashtag.

A website 104 includes one or more resources 105 associated with a domain name and hosted by one or more servers. An example website 104 is a collection of web pages formatted in hypertext markup language (HTML) that can contain text, images, multimedia content, and programming elements, such as scripts. Each website 104 can be maintained by a publisher 109, which is an entity that controls, manages and/or owns the website 104.

A resource 105 can be any data that can be provided over the network 102. A resource 105 can be identified by a resource address that is associated with the resource 105. Resources 105 include HTML pages, word processing documents, portable document format (PDF) documents, images, video, and news feed sources, to name only a few. The resources 105 can include content, such as words, phrases, videos, images and sounds, that may include embedded information (such as meta-information hyperlinks) and/or embedded instructions (such as scripts).

A user device 106 can request resources 105 from a website 104. In turn, data representing the resource 105 can be provided to the user device 106 for presentation by the user device 106. User devices 106 can also submit search queries 117 to the search system 115 over the network 102. In response to a search query 117, the search system 115 can, for example, access the indexed cache 116 to identify resources 105 that are relevant to the search query 117. The search system 115 identifies the resources 105 in the form of search results 118 and returns the search results 118 to the user devices 106 in search results pages. A search result 118 is data generated by the search system 115 that identifies a resource 105 that is responsive to a particular search query 117, and includes a link to the resource 105. An example search result 118 can include a web page title, a snippet of text or a portion of an image extracted from the web page, and the URL (Unified Resource Location) of the web page.

The data representing the resource 105 or the search results 118 can also include data specifying a portion of the resource 105 or search results 118 or a portion of a user display (e.g., a presentation location of a pop-up window or in a slot of a web page) in which other content (e.g., advertisements) can be presented. These specified portions of the resource or user display are referred to as slots or impressions. An example slot is an advertisement slot. In some implementations, the publisher 109 of a resource 105 can specify (e.g., using a publisher account management interface associated with the content management system 110) one or more hashtags to use as selection criteria for determining which content can be shown in a slot on a resource 105 associated with the publisher 109.

When a resource 105 or search results 118 are requested by a user device 106, the content management system 110 may receive a request for content to be provided with the resource 105 or search results 118. The request for content can include characteristics of one or more slots or impressions that are defined for the requested resource 105 or search results 118. For example, a reference (e.g., URL) to the resource 105 or search results 118 for which the slot is defined, a size of the slot, and/or media types that are available for presentation in the slot can be provided to the content management system 110. Similarly, keywords and/or hashtags associated with a requested resource 105 or a search query 117 for which search results 118 are requested can also be provided to the content management system 110 to facilitate identification of content that is relevant to the resource 105 or search query 117. An identifier (e.g., cookie) associated with the user device 106 can be received with the request for content.

Based, for example, on data included in the request for content, the content management system 110 can select (e.g., from a content items data store 119) content items that are eligible to be provided in response to the request. One or more selected content items can be provided to the user device 106 in association with providing an associated resource 105 or search results 118. The provided content item(s) can be presented on the user device 106, in one or more respective slots.

The content management system 110 can, for example, select a content item having characteristics matching the characteristics of a given slot. As another example, content items having selection criteria (e.g., keywords, hashtags) that match input or hashtags, in the search query 117, or content or hashtags included in the search results 118 may be selected as eligible content items by the content management system 110. As yet another example, the content management system 110 can identify a content item in the content items datastore 119 that is associated with a hashtag or keyword that matches a hashtag or keyword included in a user profile associated with the requesting user device 106. The identified content item can be selected by the content management system 110 and provided to the requesting user device 106. In some implementations, the content management system 110 can select content items based at least in part on results of an auction.

A content provider 108 or content sponsor can create a content campaign associated with one or more content items using tools provided by the content management system 110. For example, the content management system 110 can provide one or more account management user interfaces for creating and managing content campaigns. The account management user interfaces can be made available to the content provider 108, for example, either through an online interface provided by the content management system 110 or as an account management software application installed and executed locally at a content provider's client device.

A content provider 108 can, using the account management user interfaces, provide campaign parameters 113 which define a content campaign. The content campaign can be created and activated for the content provider 108 according to the parameters 113 specified by the content provider 108. The campaign parameters 113 can be stored in a campaign database 114. Campaign parameters 113 can include, for example, a campaign name, a preferred content network for placing content, a budget for the campaign, start and end dates for the campaign, a schedule for content placements, content (e.g., creatives), bids, and selection criteria. Selection criteria can include, for example, a language, one or more geographical locations or websites, and/or one or more selection terms. The selection terms can be used in evaluating when to serve content items in response to received requests for content. The selection terms, can include, for example, one or more keywords and/or hashtags.

A content provider 108 may be, for example, an entity that is associated with a brand. The content management system 110 can provide tools for entities to create campaigns that promote a brand by using content that has been created and tagged by users as being associated with, for example, a brand-related hashtag. The content management system 110 can gather content (e.g., text content, image content, video content) from plural, different content sources that are associated with hashtags, store the gathered content in a hashtagged content repository 124, and, in some implementations, index the stored content by hashtags. The content management system 110 can, for example, gather content from one or both of the first social server system 111 and the second social server system 112.

When gathering user-generated content, the content management system 110 can gather only user-generated content to which users have explicitly granted access. For example, a content provider 108 may run a brand promotion and may encourage users to post or submit content related to the brand promotion. For example, a shoe company can run a campaign centered around a #born2run hashtag and may encourage users to post running photos and other content and tag such content with the #born2run hashtag. User posts and submissions can be, for example, used as entry into a sweepstakes or other contest. The users can agree to use of content associated with a particular hashtag as part of submitting a post associated with the hashtag

The content management system 110 can provide a user interface in which the entity can provide a search query for searching for content in the hashtagged content repository 124. The search query can include, for example, one or more of a hashtag, category, or brand. Other input is possible. The content management system 110 can retrieve content from the hashtagged content repository 124 based on the search query and present the retrieved content to the entity. The entity can select one or more of the presented content items and the selection can be received by the content management system 110. The content management system 110 can automatically create a campaign for the entity, including the automatic generation of one or more creatives based on the selected content for distribution based on selection criteria associated with the campaign. Automatic creation of campaigns based on hashtagged content is discussed in more detail below.

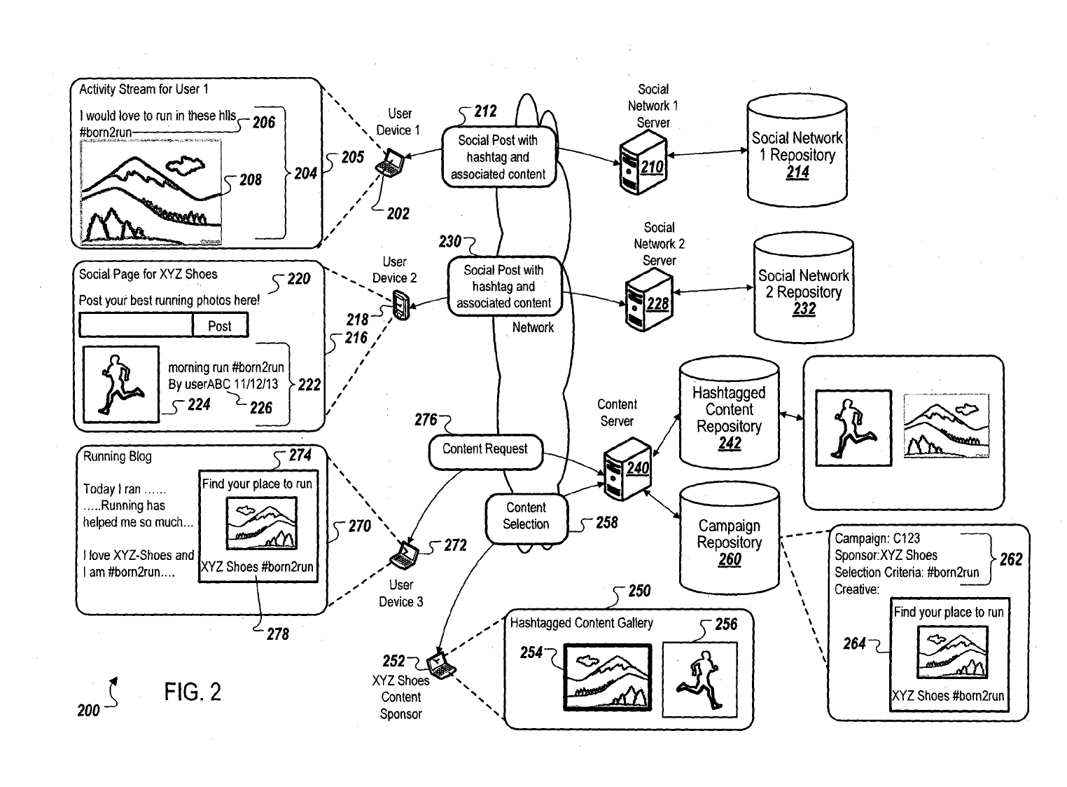

FIG. 2 illustrates an example system 200 for providing content. A user of a first user device 202 posts a message 204 to an activity stream associated with a first social network and with the user of the first user device 202. The message 204 is presented on a web page 205 and includes a hashtag 206 and an image 208. The message 204 can be sent to a first social network server 210 (e.g., as a social post 212). The message 204, including the hashtag 206 and the image 208, can be stored in a repository 214 and distributed to users of the first social network that are associated with the user of the user device 202. The hashtag 206 may be associated, for example, with an XYZ Shoes shoe manufacturer (e.g., the hashtag 206 may be promoted by the XYZ Shoes manufacturer in content campaigns and one or more of the content campaigns may encourage customers of XYZ Shoes to create and promote content and tag such content using the hashtag 206). A user can, for example, register with the XYZ Shoes entity (e.g., by entering a sweepstakes or other contests). As part of registering with the XYZ Shoes entity, the user can agree to use of content that they tag with a hashtag associated with the XYZ Shoes entity. In some implementations, the hashtag 206 can be used as an index for the social post 212 that is stored in the repository 214. For example, the repository 214 may be indexed and searchable by hashtags. The repository 214 can include metadata for each stored content item, such as a number of affinity designations (e.g., “likes”), or number of publications or re-publications of the content item. Other forms of metadata are possible.

The XYZ Shoes manufacturer may provide a social page on the first social network and/or on a second, different social network. For example, a social page 216 associated with the second social network is presented on a second user device 218. The social page 216 can be configured to allow users to post messages to the social page 216. For example, the social page 216 includes a message 220 that encourages users to post messages and images related to running. The social page 216 can explain that content that a user posts to the social page 216 may be used by the XYZ Shoes manufacturer and can allow the user to agree to such use. The social page 216 includes a post 222 (e.g., a post posted by a user of the user device 218) that includes an image 224 and a text comment 226. The text comment 226 includes the same #born2run hashtag as the message 204. The post 222 can be sent to a second social network server 228 (e.g., as a social post 230). The post 230, including the comment 226 and the image 224, can be stored in a repository 232 and distributed to users of the second social network that are associated with the user of the user device 218.

A content server 240 (or another server or system) can gather content from the first social network (e.g., from the repository 214 and/or the first social network server 210), the second social network (e.g., from the repository 232 and/or the second social network server 228), and/or from other content sources that include or present content that is associated with hashtags. In some implementations, the content server 240 can store the gathered content in a hashtagged content repository 242 and index the stored content by particular hashtags. For example, both the image 208 and the image 224 can be stored in the hashtagged content repository 242 in association with the #born2run hashtag. User-generated content stored in the hashtagged content repository 242 is content for which users have given consent for use.

A user (e.g. campaign administrator) associated with the XYZ Shoes manufacturer can view a content gallery user interface 250 on a content sponsor user device 252. The campaign administrator can, for example, use the content gallery user interface 250 to search for content associated with a hashtag, content category, or brand. For instance, the content gallery user interface 250 displays content items 254 and 256 that had previously been posted by users and associated with the #born2run hashtag.

The campaign administrator can select one or more of the presented content items (e.g., the content item 254 is shown as selected). In response to the selection, the content server 240 can receive a content selection 258 from the content sponsor user device 252. The content server 240 can automatically create a campaign for the content sponsor based on the content selection 258. For example, the content server 240 can generate a creative based on the content selection 258 and can associate the creative with a new or existing campaign and designate the creative for distribution based on selection criteria associated with the campaign. The selection criteria for the campaign can include, for example, the hashtag 206 and/or one or more selection keywords that are determined to be related to the hashtag 206. Data for the campaign and the creative can be stored in a campaign repository 260, as illustrated by example stored campaign data 262 and a creative 264.

Textual portions of the creative 264 can be automatically determined and/or provided by the content sponsor. For example, textual content can be automatically determined from a landing page associated with the content sponsor. A landing page associated with the content sponsor can be associated with the creative 264 such that the landing page is presented when the creative 264 is presented to a user and the user selects the creative 264. In some implementations, a content sponsor can edit or customize automatically generated text. Although the creative 264 includes the hashtag #born2run, automatically generated creatives are not required to include a hashtag.

After creation of the campaign, the content server 240 can serve content included in the campaign in response to received requests for content. For example, a web page 270 presented on a user device 272 includes a content slot 274. The web page 270 can be configured to send a content request 276 for the content slot 274 to the content server 240. The content server 240 can select the creative 264 in response to the content request 276 and provide the creative 264 to the user device 272 for presentation in the content slot 274, as illustrated by a displayed creative 278.

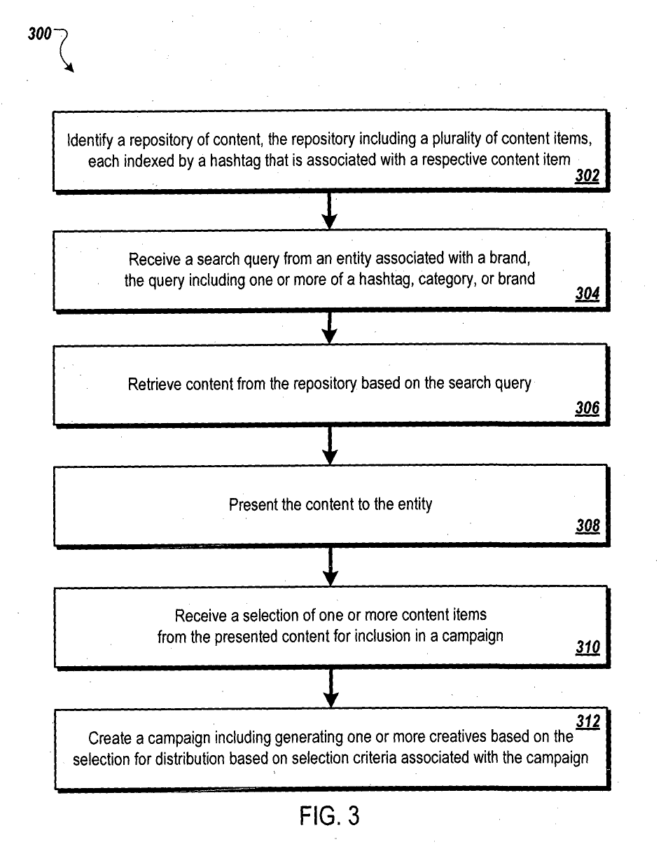

FIG. 3 is a flowchart of an example process 300 for creating a campaign. The process 300 can be performed, for example, by the content management system 110 described above with respect to FIG. 1 or the content server 240 described above with respect to FIG. 2.

A repository of content is identified (302), the repository including a plurality of content items, each indexed or grouped by a hashtag that is associated with a respective content item. The repository can include content that has been gathered from plural, different content sources. For example, the repository can include content gathered from at least two different social networks. The gathering of content can include gathering and subsequent integration with the content retrieved from one or more different content sources. The content can include textual content, image content, video content, and other types of content. User-generated content stored in the repository is content for which users have given consent for user.

The repository can include metadata for some or all stored content items. For example, metadata related to an engagement metric associated with a respective content item can be stored in the repository. For example, metadata for a content item can include one or more of a number of affinity designations, or number of publications or re-publications of the content item, a number of users who are associated with (e.g., follow) the creator of the content item, and other types of metadata. Engagement-related metadata can be aggregated from different sources for a content item. For example, a first social network can use a first type of affinity designation (e.g., a “like”), and a second social network can use a second different type of affinity designation (e.g., a “plus one”). The metadata for a content item can include a sum (e.g., weighted sum or such function) of the first type of affinity designation and the second type of affinity designation.

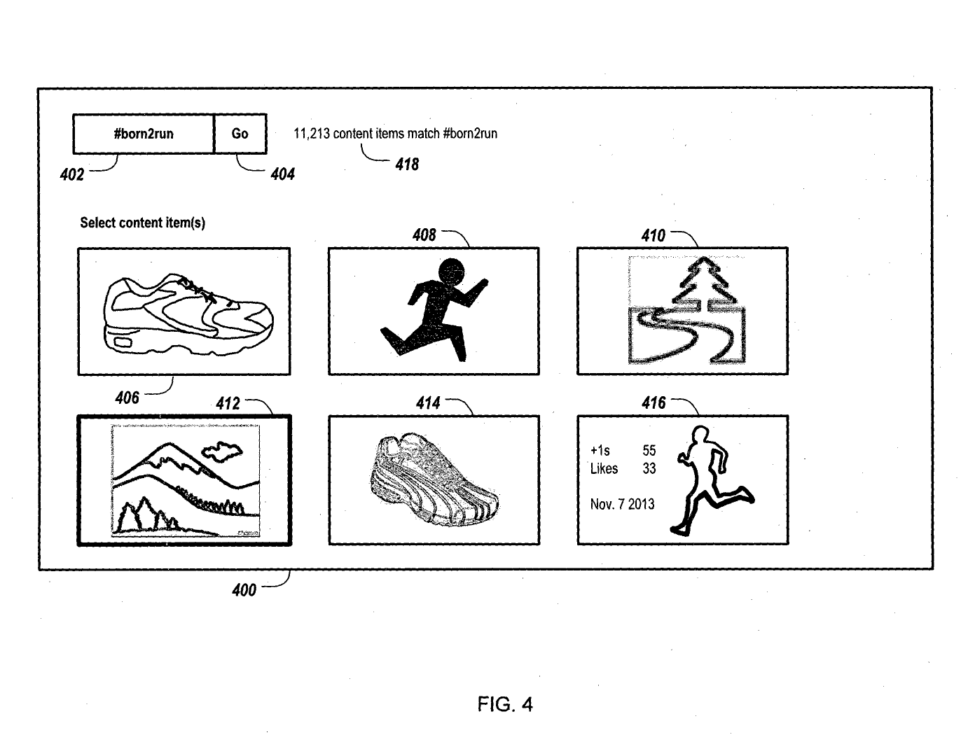

A search query is received from an entity, such as an entity associated with a brand (304), the query including one or more of a hashtag, category, or brand. The search query can be received, for example, from a user interface. For example, FIG. 4 illustrates an example content gallery user interface 400. The entity (e.g., content sponsor) can enter a search query using a control 402 and can submit the search query using a control 404. The category can indicate, for example, a media type, such as image, text, video, particular types of images (.jpg, .png), etc. The search query can include other criteria, such as a content item maximum size in bytes, a content item display size range or maximum, a date range of content creation, or a minimum engagement metric, to name a few examples.

Referring again to FIG. 3, content is retrieved from the repository based on the search query (306). For example, content that is indexed by a hashtag that matches a hashtag included in or derived from the search query can be identified in and retrieved from the repository. For instance, when the control 404 is selected, content that is indexed by the hashtag #born2run (e.g., the #born2run hashtag entered in the control 402) can be retrieved from the repository. As another example, content that is indexed by a hashtag that is related to a category, brand, or concept included in the search query can be retrieved from the repository. For instance, a search query of “XYZ Shoes” may be determined to match hashtags of #born2run, #running, and #runningShoes. In some implementations, when the search query includes only a hashtag, top ranked content from the repository that is associated with the hashtag can be retrieved. In some implementations, when the search query includes a hashtag and a category, top ranked content from the repository that are associated with the hashtag and the category can be retrieved. In some implementations, when the search query does not include a hashtag, one or more hashtags that are related to the search query can be identified and top ranked content from the repository that is associated with the one or more hashtags can be retrieved.

The content is presented to the entity (308). For example, the content can be presented to the entity in a user interface. For example, as shown in FIG. 4, content items 406-416 are presented in the content gallery user interface 400. The content items can be presented, for example, according to popularity ranking. Accordingly, the entity can view content that has been most linked or associated by customers to the entity brand or domain of expertise of the entity. The content gallery user interface 400 can allow the entity to scroll to see content items other than those initially displayed. As shown in the content item 416, engagement metrics and/or a date of content creation, and/or other metadata can be presented along with the content item. As shown by a message 418, a number of content items matching the query can be presented.

Referring again to FIG. 3, a selection of one or more content items is received from the presented content for inclusion in a campaign (310). For example, the selection can be received from a user interface. For instance, in the example of FIG. 4, a selection of the content item 412 can be received.

A campaign is created, including generating one or more creatives based on the selection for distribution based on selection criteria associated with the campaign (512). For example, one or more creatives can be automatically generated that each include a selected content item. The creatives can also include automatically generated text, such as text retrieved from a landing page associated with the entity. The entity can also provide text or other types of content to include in a creative. The entity can customize auto-generated text. In some implementations, the entity approves the creatives before the creatives are included in the campaign.

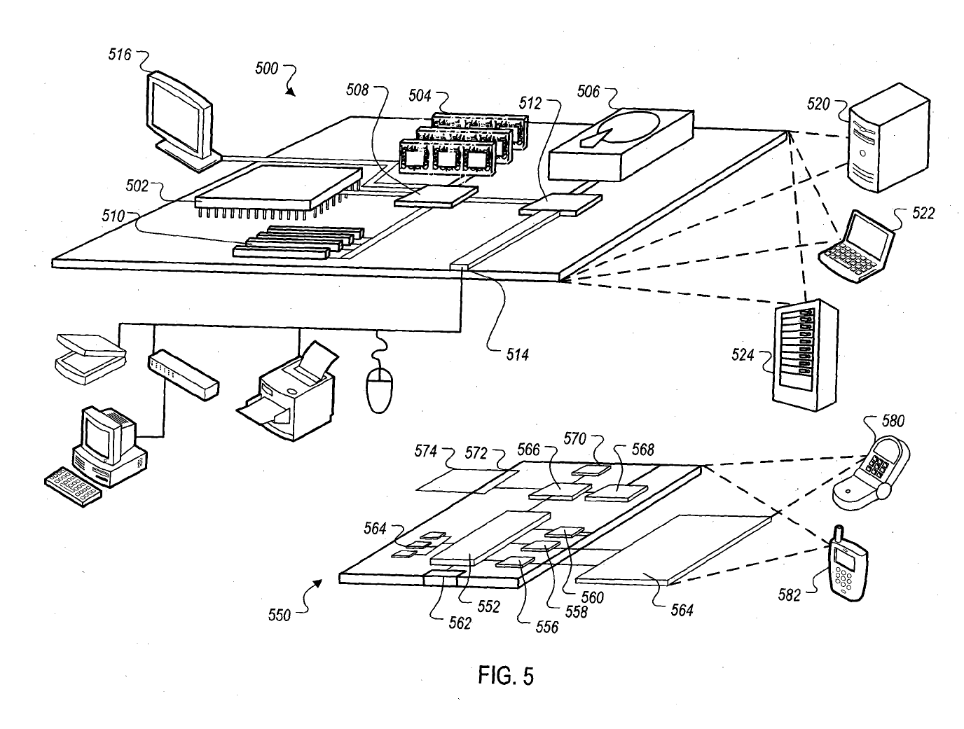

FIG. 5 is a block diagram of computing devices 500, 550 that may be used to implement the systems and methods described in this document, as either a client or as a server or plurality of servers. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be illustrative only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a computer-readable medium. The computer-readable medium is not a propagating signal. In one implementation, the memory 504 is a volatile memory unit or units. In another implementation, the memory 504 is a non-volatile memory unit or units.

The storage device 506 is capable of providing mass storage for the computing device 500. In one implementation, the storage device 506 is a computer-readable medium. In various different implementations, the storage device 506 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of duties is illustrative only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can process instructions for execution within the computing device 550, including instructions stored in the memory 564. The processor may also include separate analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD display or an OLED display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication (e.g., via a docking procedure) or for wireless communication (e.g., via Bluetooth® or other such technologies).

The memory 564 stores information within the computing device 550. In one implementation, the memory 564 is a computer-readable medium. In one implementation, the memory 564 is a volatile memory unit or units. In another implementation, the memory 564 is a non-volatile memory unit or units. Expansion memory 574 may also be provided and connected to device 550 through expansion interface 572, which may include, for example, a SIMM card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth®, WiFi, or other such transceiver (not shown). In addition, GPS receiver module 570 may provide additional wireless data to device 550, which may be used as appropriate by applications running on device 550.

Device 550 may also communicate audibly using audio codec 560, which may receive spoken information from a user and convert it to usable digital information. Audio codex 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the payment systems and methods have been described, it should be recognized that numerous other applications are contemplated. Accordingly, other embodiments are within the scope of the following claims.

What is claimed is:

1. A computer implemented method comprising:
identifying a repository of content, the repository including a plurality of content items, each indexed by a hashtag that is associated with a respective content item;
receiving a search query from an entity associated with a brand, the query including one or more of a hashtag, category, or brand;
retrieving content from the repository based on the search query;
presenting the content to the entity and receiving a selection of one or more content items from the presented content for inclusion in a campaign; and
creating a campaign including generating one or more creatives based on the selection for distribution based on selection criteria associated with the campaign.

2. The method of claim 1 wherein identifying the repository further includes gathering content from plural, different content sources that are associated with hashtags and storing the content in the repository.

3. The method of claim 2 wherein gathering the content includes gathering content from at least two different social networks.

4. The method of claim 2 wherein gathering content includes gathering metadata related to an engagement metric associated with a specific content item and storing the metadata along with the content in the repository.

5. The method of claim 4 wherein the metadata includes one or more of a number of affinity designations, or number of publications or re-publications of the specific content item.

6. The method of claim 4 wherein presenting includes presenting the metadata for each content item presented.

7. The method of claim 2 wherein gathering content further includes integrating a portion of an application that generates the creative in one or more networks or applications that are the source of the content.

8. The method of claim 1 wherein the search query includes only a hashtag and wherein retrieving includes retrieving top ranked content from the repository that is associated with the hashtag.

9. The method of claim 1 wherein the search query includes a hashtag and a category and wherein retrieving includes retrieving top ranked content from the repository that are associated with the hashtag and the category.

10. The method of claim 9 wherein the category is a type of content item.

11. The method of claim 1 wherein presenting the content includes presenting top ranked content from the repository based on one or more measures of popularity.

12. The method of claim 1 wherein generating the one or more creatives includes generating one creative from the selection and content received from the entity.

13. The method of claim 12 wherein the content received from the entity is an identification of a landing page to be associated with the creative.

14. The method of claim 12 wherein the content received is textual content to include along with the selection in the creative.

15. The method of claim 1 wherein the selection includes two content items and wherein generating the one or more creative includes generating two different creatives from the selection each including one of the two content items.

16. The method of claim 1 wherein the search query does not include a hashtag and wherein retrieving content from the repository based on the search query includes identifying one or more hashtags that are related to the search query and retrieving top ranked content from the repository that is associated with the one or more hashtags.

17. A computer program product tangibly embodied in a computer-readable storage device and comprising instructions that, when executed by a processor, cause the processor to:
identify a repository of content, the repository including a plurality of content items, each indexed by a hashtag that is associated with a respective content item;
receive a search query from an entity associated with a brand, the query including one or more of a hashtag, category, or brand;
retrieve content from the repository based on the search query;
present the content to the entity and receiving a selection of one or more content items from the presented content for inclusion in a campaign; and
create a campaign including generating one or more creatives based on the selection for distribution based on selection criteria associated with the campaign.

18. The product of claim 17 wherein the metadata includes one or more of a number of affinity designations, or number of publications or re-publications of the specific content item.

19. A system comprising:
one or more processors; and
one or more memory elements including instructions that when executed cause the one or more processors to:
identify a repository of content, the repository including a plurality of content items, each indexed by a hashtag that is associated with a respective content item;
receive a search query from an entity associated with a brand, the query including one or more of a hashtag, category, or brand;
retrieve content from the repository based on the search query;
present the content to the entity and receiving a selection of one or more content items from the presented content for inclusion in a campaign; and
create a campaign including generating one or more creatives based on the selection for distribution based on selection criteria associated with the campaign.

20. The system of claim 19 wherein the metadata includes one or more of a number of affinity designations, or number of publications or re-publications of the specific content item.
